(19) United States
(12) Patent Application Publication
(10) Pub. No.: US 2018/0321907 A1
(43) Pub. Date: Nov. 8, 2018

(54) ACOUSTIC PATTERN LEARNING METHOD AND SYSTEM

(71) Applicants: HYUNDAI MOTOR COMPANY, Seoul (KR); KIA MOTORS CORPORATION, Seoul (KR)

(72) Inventors: Hui Sung LEE, Gunpo-si (KR); Hyoung SHIN, Yongin-si (KR); Youngwook SONG, Seoul (KR); Kichang YI, Suwon-si (KR)

(21) Appl. No.: 15/834,994

(22) Filed: Dec. 7, 2017

(30) Foreign Application Priority Data
May 2, 2017 (KR) 10-2017-0056075

(51) Int. Cl. G06F 3/16; G10L 15/02; G10L 15/22

(52) U.S. Cl. CPC G06F 3/167; G10L 15/22; G10L 15/02

(57) ABSTRACT

An acoustic pattern learning method includes setting a learning mode according to a learning start instruction received from a mobile device, receiving an acoustic signal a preset number of times, providing information on the acoustic signal each time the acoustic signal is received, receiving a feature of an Auditory User Interface (AUI) pattern recognized by the mobile device and registering the feature of the AUI pattern as corresponding to a preset function.

### CROSS-REFERENCE TO RELATED APPLICATION

This application claims the benefit of priority to Korean Patent Application No. 10-2017-0056075, filed with the Korean Intellectual Property Office on May 2, 2017, the entire contents of which are incorporated herein by reference.

### TECHNICAL FIELD

The present disclosure relates to a method of learning an acoustic pattern or a rhythm pattern for Auditory User Interface (AUI) of a vehicle.

### BACKGROUND

Auditory User Interface (AUI) technology is a user interface (UI) technology using a sound, that is, a frequency, and has been used in various electronic devices including a vehicle. A specific acoustic pattern or a specific rhythm pattern is previously stored for the AUI, and a setting is achieved, or determined, to execute an operation or a function corresponding to the stored acoustic pattern or rhythm pattern. Next, if a user generates the stored acoustic pattern or rhythm pattern, the corresponding operation or function is executed.

The AUI technology according to the related art fixes and uses the specific acoustic pattern or the specific rhythm pattern. That is, according to the related art, an acoustic pattern or a specific rhythm pattern corresponding to each function or operation is previously determined and stored by a designer or a manufacturer. The user performs an operation of generating the stored acoustic pattern or specific rhythm pattern regardless of an intent thereof.

In this case, in order to increase a recognition rate with respect to an acoustic pattern or a rhythm pattern input from a user, after the same acoustic pattern or the same specific rhythm pattern are generated intended for a plurality of ordinary persons, an average of the acoustic patterns or the rhythm patterns generated from the plurality of ordinary persons is used as the acoustic patterns or the rhythm pattern stored by the designer or the manufacturer.

Accordingly, a system recognizes acoustic patterns or rhythm patterns generated by most users to operate. However, the system cannot recognize acoustic patterns or rhythm patterns which do not correspond to the average generated by partial users.

Further, in the trend in which individual needs are increased, this results in an increase of a need to operate the system with an acoustic pattern or a rhythm pattern by only the individual. The AUI technology according to the related cannot fully meet the requirements.

The above information disclosed in this Background section is only for enhancement of understanding of the background of the disclosure and therefore it may contain information that does not form the prior art that is already known in this country to a person of ordinary skill in the art.

### BRIEF SUMMARY

The present disclosure has been made in an effort to provide an acoustic pattern learning method and a system thereof having advantages of operating electronic devices such as a vehicle by an acoustic pattern or a rhythm pattern according to individual characteristics.

An exemplary embodiment of the present disclosure provides an acoustic pattern learning method and a system thereof capable of frequently changing an acoustic pattern and a rhythm pattern corresponding to a specific function by learning the acoustic pattern and the rhythm pattern.

An exemplary embodiment according to the present disclosure may be used to achieve other objects which are not described in addition to the objective.

According to an exemplary embodiment of the present disclosure to achieve the objective, an acoustic pattern learning method is provided. The acoustic pattern learning method includes: setting a learning mode according to a learning start instruction received from a mobile device; receiving an acoustic signal a preset number of times; providing information on the acoustic signal each time the acoustic signal is received; receiving a feature of an Auditory User Interface (AUI) pattern recognized by the mobile device; and registering the feature of the AUI pattern corresponding to a preset function.

The acoustic pattern learning method may further include analyzing a rhythm pattern of each acoustic signal received to extract knock interval information when the AUI pattern is a rhythm pattern, wherein information on the acoustic signal is the knock interval information, and the feature of the AUI pattern comprises knock interval information which is an average of knock interval information on a rhythm pattern of each acoustic signal.

When the AUI pattern is an acoustic pattern, the information on the acoustic signal includes acoustic data of a preset time length, and the feature of the AUI pattern comprises a feature point and a classifier coefficient with respect to acoustic data received a preset number of times.

According to another exemplary embodiment of the present disclosure to achieve the objective, an acoustic pattern learning system is provided. The acoustic pattern learning system includes an Auditory User Interface (AUI) module mounted in an electronic device; and a mobile device communicating with the AUI module in a wired or wireless scheme.

The mobile device includes: a learning support device configured to change a mode of the AUI module to a learning mode according to a request from a user; a learning device configured to recognize a feature of an AUI pattern by learning the AUI pattern a preset number of times received from the AUI module and to provide the recognized feature of the AUI pattern to the AUI module; and an output device configured to output the AUI pattern input from the user in cooperation with the learning device so that the user confirms the AUI pattern.

The AUI module includes an AUI control device configured to change and set a mode according to instruction of the learning support device and to control an operation corresponding to a preset mode to be performed; and an AUI device configured to provide information on an input acoustic signal to the mobile device in the learning mode, and to register the feature of the AUI pattern corresponding to a preset function when the feature of the AUI pattern is received from the mobile device.

The AUI module extracts the feature of the AUI pattern by analyzing the AUI pattern of the input acoustic signal in a normal mode, and compares the extracted feature of the AUI pattern with the feature of the AUI pattern in the learning mode, and instructs the preset function to be performed when the extracted feature of the AUI pattern corresponds to the feature of the AUI pattern.

When the AUI pattern is a rhythm pattern, information on the acoustic signal is the knock interval information on a rhythm pattern of each acoustic signal received.

When the AUI pattern is an acoustic pattern, the information on the acoustic signal includes acoustic data of a preset time length, and the feature of the AUI pattern comprises a feature point and a classifier coefficient with respect to acoustic data received a preset number of times.

According to an exemplary embodiment of the present disclosure, since an acoustic pattern or a rhythm pattern generated from a user can be used after the acoustic pattern or the rhythm pattern, an operation or a function of an electronic device may be stably executed without an error with respect to a recognition rate.

### BRIEF DESCRIPTION OF THE DRAWINGS

FIG. 1 is a block diagram illustrating an acoustic pattern learning system according to a first exemplary embodiment of the present disclosure.

FIG. 2 is a block diagram illustrating an AUI device according to an exemplary embodiment of the present disclosure.

FIG. 3 is a flowchart illustrating an acoustic pattern learning method according to a first exemplary embodiment of the present disclosure.

FIG. 4 is a flowchart illustrating an acoustic pattern learning method according to a second exemplary embodiment of the present disclosure.

FIG. 5 is a block diagram illustrating an acoustic pattern learning system according to a second exemplary embodiment of the present disclosure.

FIG. 6 is a flowchart illustrating an acoustic pattern learning method according to a third exemplary embodiment of the present disclosure.

FIG. 7 is a flowchart illustrating an acoustic pattern learning method according to a fourth exemplary embodiment of the present disclosure.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification. Further, a detailed description of a technology well known in the art is omitted.

In the specification, unless explicitly described to the contrary, the word “comprise” and variations such as “comprises” or “comprising,” will be understood to imply the inclusion of stated elements but not the exclusion of any other elements. Moreover, the terms “device” and “module” described in the specification mean a device to process at least one function or operation, which may be implemented by hardware, software, or the combination of hardware and software.

Hereinafter, an acoustic pattern learning method and a system thereof according to exemplary embodiments of the present disclosure will be described in detail with reference to the accompanying drawings.

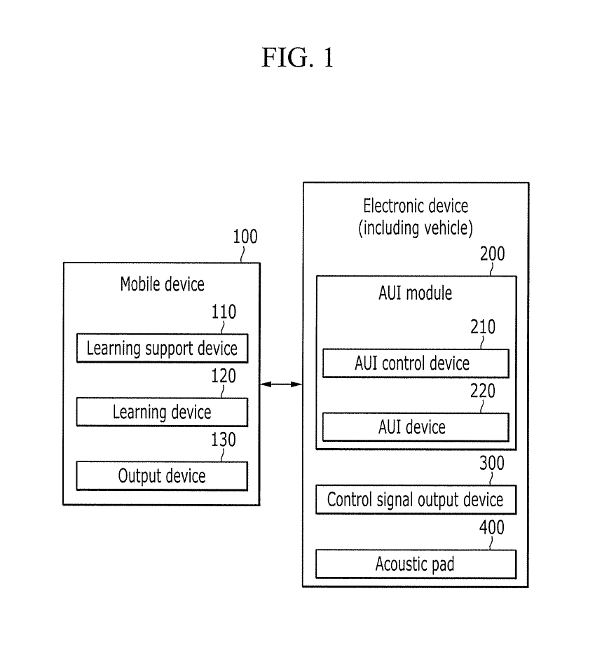

FIG. 1 is a block diagram illustrating an acoustic pattern learning system according to a first exemplary embodiment of the present disclosure. Referring to FIG. 1, an acoustic pattern learning system according to a first exemplary embodiment of the present disclosure includes an AUI module 200 mounted on an electronic device such as a vehicle, and a mobile device 100 communicating with the AUI module 200 in a wired or wireless scheme and in which a pattern learning application (APP) for setting AUI is installed. The electronic device is a device such as vehicles, motorcycles, computers, and TVs on which various functions are mounted. The AUI module 200, in some embodiments, is implemented with a hardware processor having instructions to perform AUI module 200 functions described in this disclosure.

The mobile device 100 is a portable communication device such as a smart phone or a tablet PC, or a laptop which has a communication function. The mobile device 100 is installed therein with the pattern learning APP for setting AUI. In this case, the pattern learning APP performs a function of a learning support device 110 and a learning device 120.

The learning support device 110 communicates with an AUI module 200 through a wired communication module or a wireless communication module of the mobile device 100, sets a mode of an AUI control device 210 as a learning mode or a normal mode, and provides guide information to a user that allows to register the acoustic pattern and the rhythm pattern. Hereinafter, the acoustic pattern and the rhythm pattern are referred to as an “AUI pattern”.

The learning device 120 recognizes a feature of an acoustic pattern or a feature of a rhythm pattern by learning an AUI pattern which is sequentially received from the AUI module 200 the preset number of times, and provides the recognized feature of an acoustic pattern or the recognized feature of a rhythm pattern to the AUI module 200 to be registered.

In this case, the feature of the acoustic pattern includes a feature point of the acoustic wave forming the acoustic pattern and a classifier coefficient. The feature of the rhythm pattern includes knock interval information recognized from an acoustic wave forming the rhythm pattern. The acoustic wave includes a plurality of feature pints according to a sampling time or a frequency hand. In this case, the feature point of the acoustic wave is feature information capable of being distinguished from other acoustic wave. For example, the feature point of the acoustic wave includes a Fast Fourier Transform (FFT) value or a Spectrogram) in a frequency domain. The feature point of the acoustic wave includes an initial slope and a latter slope of waveform and flow of power in a time domain. In addition, the classifier coefficient is calculated using a plurality of feature points of a corresponding acoustic wave.

The output device 130 outputs an AUI pattern input from a user through a sound or a screen in cooperation with the learning device 120 so that the user may confirm the output AUI pattern.

The AUI module 200 mounted on an electronic device such as a vehicle allows a user to register a specific AUI pattern to match with a specific function in cooperation with the mobile device 100. The AUI module 200 determines whether the AUI pattern input from the user is the same as the registered AUI pattern after registration of the specific AUI pattern by comparing the input AUI pattern with the registered AUI pattern. When the input AUI pattern is the same as the registered AUI pattern, the AUI module 200 controls a control signal output device 300 to output a control signal corresponding to a corresponding function so that a specific function is performed.

Accordingly, the AUI module 200 includes an AUI control device 210 and an AUI device 220.

The AUI control device 210 sets a mode to control an operation of the AUI device 220 according to instructions of the learning support device 110. For example, the AUI control device 210 sets a learning mode according to instruction of the learning support device 110, and controls the AUI device 220 to perform an operation corresponding to a predetermined learning mode. Furthermore, the AUI control device 210 sets a normal mode according to release instruction of the learning mode from the learning support device 110, and controls the AUI device 220 to perform an operation corresponding to a preset normal mode.

The AUI device 220 provides information (e.g., acoustic signal or knock interval information) on an acoustic signal of AUI pattern input in the learning mode to the mobile device 100. If the AUI device 220 receives a feature of the acoustic pattern or a feature of the rhythm pattern from the mobile device 100, the AUI device 220 corresponds the feature of the acoustic pattern or the feature of the rhythm pattern to a preset function (function requested from the user) among a plurality of functions of the electronic device to register (update) the above corresponding result. Further, the AUI device 220 recognizes a feature of a corresponding pattern with respect to the AUI pattern in a normal mode. When the recognized feature of a corresponding pattern corresponds to the registered feature of the AU pattern, the AUI device 220 reports pattern corresponding to the control signal output device 300 so that a control signal is output to perform a preset function corresponding to the AUI pattern.

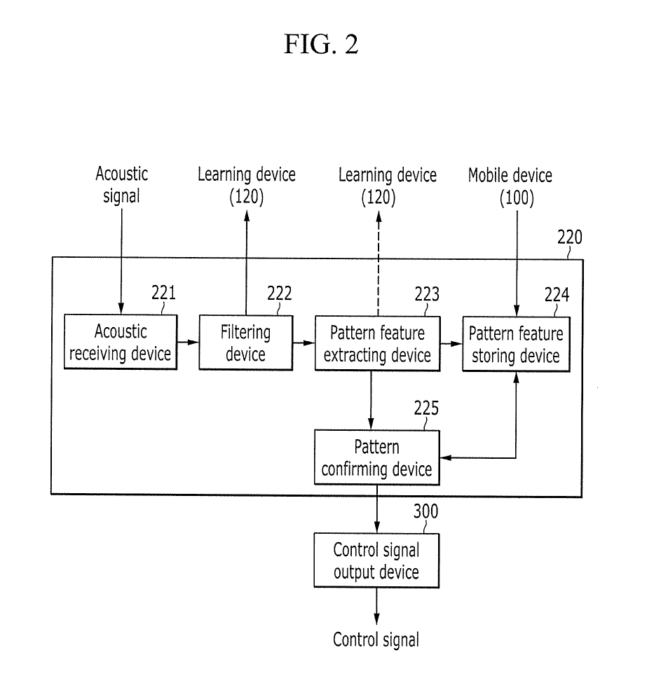

Hereinafter, the AUI device 220 will be described in detail with reference to FIG. 2. FIG. 2 is a block diagram illustrating an AUI device according to an exemplary embodiment of the present disclosure.

Referring to FIG. 2, the AUI device 220 according to an exemplary embodiment of the present disclosure includes an acoustic receiving device 221, a filtering device 222, a pattern feature extracting device 223, a pattern feature storing device 224 and a pattern confirming device 225.

The acoustic receiving device 221 receives an acoustic signal generated by an acoustic pad 400 (e.g., acoustic generator disclosed in patent No. 10-1371749) configured to generate various types of acoustic waves, or an acoustic signal generated when a user knocks a part of the electronic device, for example, a sliding door external plate, a rear lamp, steering wheel or the like of a vehicle. For example, the acoustic receiving device 221 includes a sensor such as a small microphone, a piezo-sensor, and an accelerometer sensor which may acquire an acoustic signal.

The filtering device 222 performs frequency filtering with respect to the acoustic signal received by the acoustic receiving device 221 to remove noises included in the acoustic signal. If the learning device 120 has a function of extracting a feature of an acoustic pattern or a feature of a rhythm using an acoustic signal like the pattern feature extracting device 223, the filtering device 222 provides the acoustic signal filtered when the learning mode is set to the learning device 120. Further, in the normal mode, the filtering device 222 provides the filtered acoustic signal to the pattern feature extracting device 223.

The pattern feature extracting device 223 extracts the feature of the AUI pattern with respect to the acoustic signal filtered by the filtering device 222. When the learning device 120 does not have a function of extracting the feature of the AUI pattern using the acoustic signal, the pattern feature extracting device 223 provides the feature of the AUI pattern when the learning mode is set to the learning device 120. In this case, the learning device 120 does not have a function of extracting the feature of the AUI pattern using the acoustic signal. In addition, in a case of the normal mode, the pattern feature extracting device 223 provides the extracted feature of the AUI pattern to the pattern confirming device 225.

A pattern feature storing device 224 stores features of the AUI pattern corresponding to each function. At least one of the features of the AUI pattern stored in the pattern feature storing device 224 is learned by the learning device 120. The pattern confirming device 225 determines whether the feature of the AUI pattern extracted by the pattern feature extracting device 223 corresponds to the feature of the AUI pattern stored in the pattern feature storing device 224. When the extracted feature of the AUI pattern corresponds to the stored feature of the AUI pattern, the pattern confirming device 225 reports a function corresponding to the AUI pattern to the control signal output device 300.

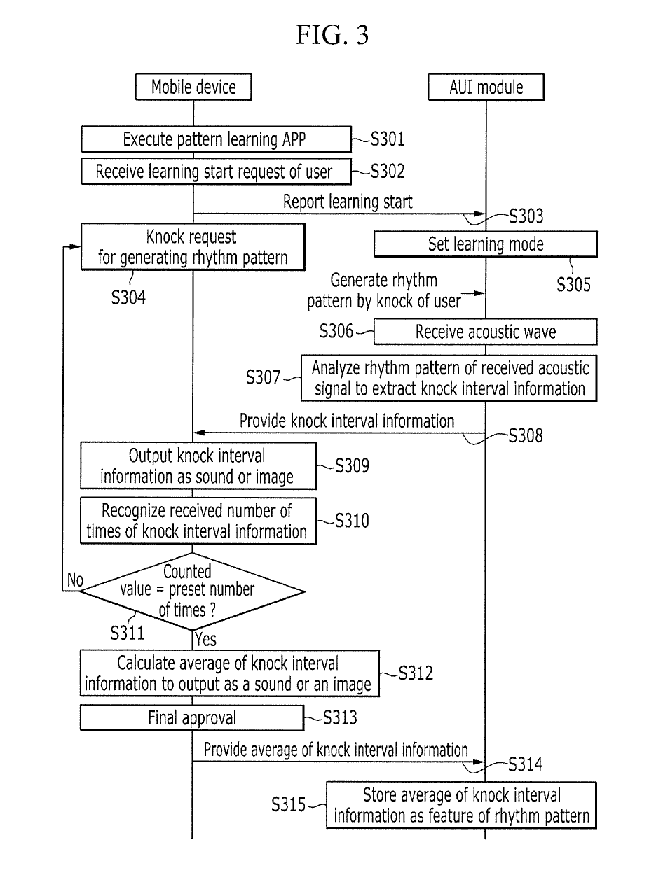

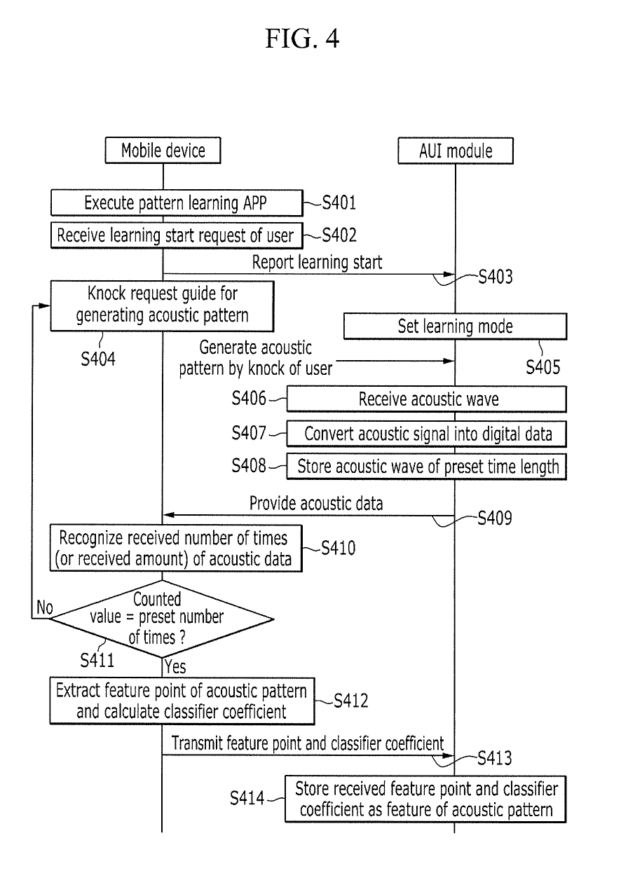

Hereinafter, an acoustic pattern learning method according to exemplary embodiments of the present disclosure will be described with reference to FIG. 3 and FIG. 4.

FIG. 3 is a flowchart illustrating an acoustic pattern learning method according to a first exemplary embodiment of the present disclosure, which relates to a method of learning a rhythm pattern using the acoustic pattern learning system according to a first exemplary embodiment of the present disclosure.

Referring to FIG. 3, a user executes a pattern learning APP from a mobile device 100 in a communication connection state so that the mobile device 100 communicates with an AUI module 200 in a wired or wireless scheme (S301). If executing the pattern learning APP, the mobile device 100 and the AUI module 200 may be connected to each other in a wireless communication scheme.

The activated pattern learning APP displays a screen window for learning a rhythm pattern on a screen, and the user selects a start button indicating start of a rhythm pattern learning on a screen window (S302). Accordingly, the pattern learning APP provides a signal indicating start of the rhythm pattern learning to the AUI module 200 (S303).

Simultaneously, the pattern learning APP displays a guide of contents which allows a user to knock an electronic device to generate a rhythm pattern on a screen (S304), and the user knocks the electronic device using a hand or other tool to generate a desired rhythm pattern of the user.

If the AUI module 200 receives a signal indicating start of a rhythm pattern learning from the mobile device 100, the AUI module 200 sets a learning mode (S305), and receives an acoustic signal of a rhythm pattern generated by the user (S306).

The AUI module 200 analyzes a rhythm pattern of the received acoustic signal to extract interval information per knock, or, knock interval information (S307), and provides the extracted knock interval information to the pattern learning APP (S308). If the pattern learning APP receives the knock interval information, the pattern learning APP outputs the knock interval information as a sound or an image (e.g., graph or picture) so that the user may confirm a rhythm pattern generated by the user (S309).

The pattern learning APP counts the received number of times of the knock interval information from the AUI module 200 (S310), and determines whether the counted value is a preset number of times (e.g., 2 times, 3 times, 4 times) (S311). If the counted value is less than the preset number of times, step S304 is performed and step S306 to step S310 are repeated the preset number of times.

If the knock interval information is received the preset number of times, the pattern learning APP outputs knock interval information obtained by averaging the received knock interval information, that is, by averaging interval information per knock as a sound or an image so that the user may confirm the knock interval information (S312). If the user approves the knock interval information obtained by the averaging (S313), the pattern learning APP provides the knock interval information obtained by the averaging to the AUI module 200 (S314).

If the AUI module 200 receives the knock interval information from the mobile device 100, the AUI module 200 registers (stores) the knock interval information as a feature of the rhythm pattern with respect to a preset function (S315).

FIG. 4 is a flowchart illustrating an acoustic pattern learning method according to a second exemplary embodiment of the present disclosure, which relates to a method of learning an acoustic pattern using the acoustic pattern learning system according to the first exemplary embodiment of the present disclosure.

Referring to FIG. 4, a user executes a pattern learning APP from the mobile device 100 (S401). The pattern learning APP activated by the execution displays a screen window for learning an acoustic pattern on a screen so that the user selects a start button indicating start of acoustic pattern learning on the screen window (S402). Accordingly, the pattern learning APP provides a signal indicting start of the acoustic pattern learning to the AUI module 200 (S403).

Simultaneously, the pattern learning APP displays a guide including contents that allows the user to generate an acoustic pattern by operating an acoustic pad 400 (S404), and the user operates the acoustic pad 400 using a hand or other tool to generate a desired acoustic pattern of the user.

If the AUI module 200 receives a signal indicating start of acoustic pattern learning from the mobile device 100, the AUI module 200 sets a learning mode (S405). The AUI module 200 receives an acoustic signal of the acoustic pattern generated by the user (S406), converts the received acoustic signal into digital data (S407), stores the acoustic signal of a preset time length (e.g., 100 ms, 200 ms) (S408), and provides the stored acoustic data of the preset time length to the mobile device 100 (S409).

The pattern learning APP counts the received number of times of the acoustic data when the pattern learning APP receives the acoustic data (S410), and determines whether the counted value is a preset number of times (e.g., twice, 3 times, 4 times) (S411). If the counted value is less than the preset number of times, step S404 is performed so that step S406 to step S410 are repeated the preset number of times. Meanwhile, if the pattern learning APP receives the acoustic data from the AUI module 200, the pattern learning APP determines whether an amount of the received acoustic data is a preset amount of data. If the amount of the received acoustic data is less than the preset amount of data, step S404 is performed so that step S406 to step S410 are repeated the preset number of times.

If the pattern learning APP receives the acoustic data the preset number of times, the pattern learning APP analyzes the received acoustic data to extract an important feature point of the acoustic pattern and to calculate a classifier coefficient (S412). Further, the pattern learning APP provides the extracted important feature point of the acoustic pattern and the calculated classifier coefficient to the AUI module 200 (S413). If the AUI module 200 receives the important feature point and the classifier coefficient from the mobile device 100, the AUI module 200 registers (stores) the important feature point and the classifier coefficient as a feature of an acoustic pattern with a preset function (S414).

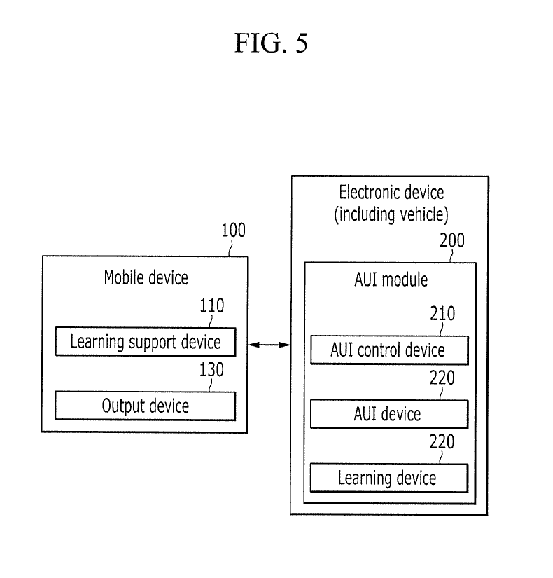

Hereinafter, an acoustic pattern learning system according to the second exemplary embodiment of the present disclosure will be described with reference to FIG. 5

FIG. 5 is a block diagram illustrating an acoustic pattern learning system according to a second exemplary embodiment of the present disclosure. The acoustic pattern learning system according to the second exemplary embodiment of the present disclosure is applied to a case of performing a learning function in the AUI module 200.

Referring FIG. 5, the acoustic pattern learning system according to the second exemplary embodiment of the present disclosure have substantially the same as the first exemplary embodiment of the present disclosure. The difference is that a learning device 120 of the mobile device 100 is omitted but a learning device 230 is added to the AUI module 200. In this case, the pattern learning APP installed in the mobile device 100 performs a function of the learning support device 110.

Moreover, the AUI control device 210 activates the learning device 230 upon setting a learning mode and inactivates the learning device 230 upon setting the normal mode.

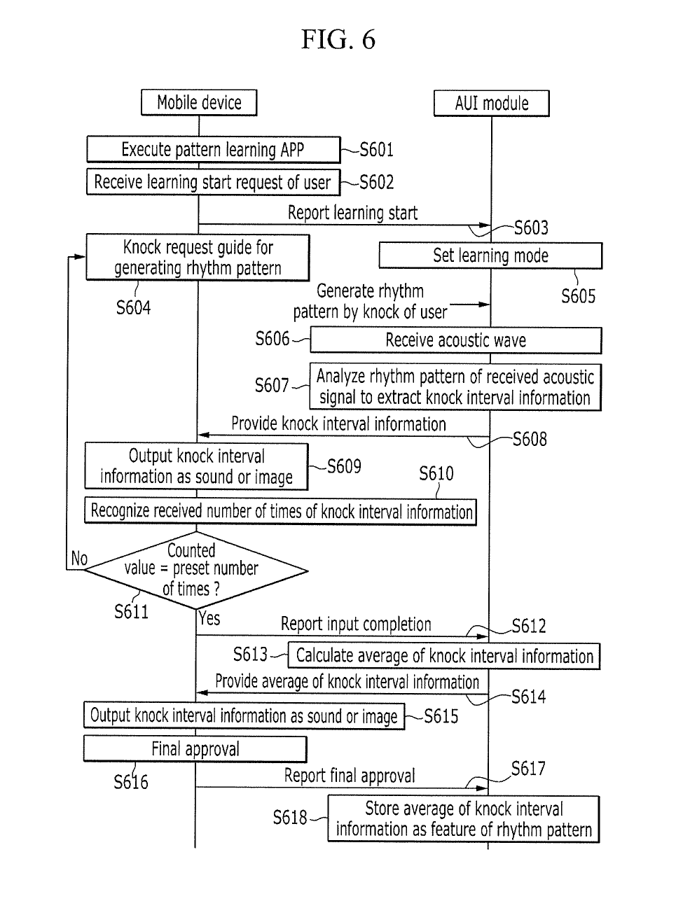

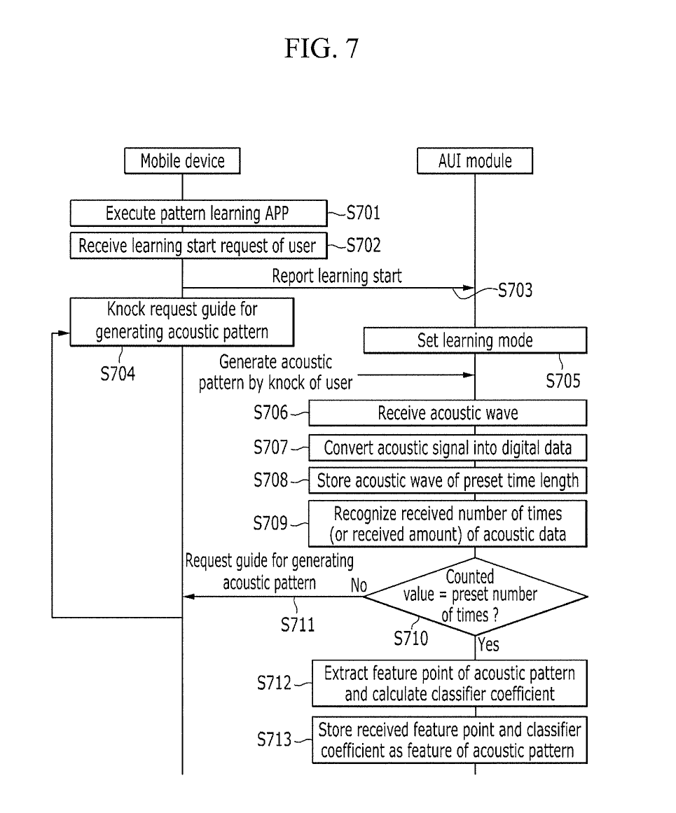

Hereinafter, an acoustic pattern learning method according to a second exemplary embodiment of the present disclosure will be described with reference to FIG. 6 and FIG. 7.

FIG. 6 is a flowchart illustrating an acoustic pattern learning method according to a third exemplary embodiment of the present disclosure. Referring FIG. 6, a user executes a pattern learning APP from a mobile device 100 (S601). The pattern learning APP activated by the execution displays a screen window for learning a rhythm pattern on a screen so that the user selects a start button indicating start of rhythm pattern learning on the screen window (S602). Accordingly, the pattern learning APP provides a signal indicting start of the rhythm pattern learning to the AUI module 200 (S603).

Simultaneously, the pattern learning APP displays a guide including contents that allows the user to generate a rhythm pattern by knocking an electronic device (604), and the user knocks the electronic device using a hand or other tool to generate a desired rhythm pattern of the user.

If the AUI module 200 receives a signal indicating start of rhythm pattern learning from the mobile device 100, the AUI module 200 sets a learning mode (S605) and receives an acoustic signal of the rhythm pattern generated by the user (S606)

The AUI module 200 analyzes a rhythm pattern of the received acoustic signal to extract interval information per knock, or, knock interval information (S607), and provides the extracted knock interval information to the pattern learning APP (S608). If the pattern learning APP receives the knock interval information, the pattern learning APP outputs the knock interval information as a sound or an image (e.g., graph or picture) so that the user may confirm a rhythm pattern generated by the user (S609).

The pattern learning APP counts the received number of times of the knock interval information from the AUI module 200 (S610), and determines whether the counted value is a preset number of times (e.g., 2 times, 3 times, 4 times) (S611). If the counted value is less than the preset number of times, step S604 is performed and step S606 to step S610 are repeated the preset number of times.

If the knock interval information is received the preset number of times, the pattern learning APP reports it to the AUI module 200 (S612), and the AUI module 200 obtains an average of the received knock interval information, that is, intervals per knock (S613), and provides the obtained knock interval information to the pattern learning APP (S614). Accordingly, the pattern learning APP outputs the received knock interval information as a sound or an image so that the user may confirm the knock interval information (S615).

If the user approves the knock interval information (S616), the pattern learning APP reports a final approval to the AUI module 200 (S617), and the AUI module 200 registers (stores) the knock interval information obtained by the averaging as a feature of a rhythm pattern with respect to a preset function (S618).

FIG. 7 is a flowchart illustrating an acoustic pattern learning method according to a fourth exemplary embodiment of the present disclosure.

Referring to FIG. 7, a user executes a pattern learning APP from the mobile device 100 (S701). The pattern learning APP activated by the execution displays a screen window for learning an acoustic pattern on a screen so that the user selects a start button indicating start of acoustic pattern learning on the screen window (S702). Accordingly, the pattern learning APP provides a signal indicting start of the rhythm pattern learning to the AUI module 200 (S703).

Simultaneously, the pattern learning APP displays a guide including contents that allows the user to generate an acoustic pattern by operating an acoustic pad 400 (S704), and the user operates the acoustic pad 400 using a hand or other tool to generate a desired acoustic pattern of the user.

If the AUI module 200 receives a signal indicating start of acoustic pattern learning from the mobile device 100, the AUI module 200 sets a learning mode (S705). The AUI module 200 receives an acoustic signal of the acoustic pattern generated by the user (S706), converts the received acoustic signal into digital data (S707) and stores the acoustic signal of a preset time length (e.g., 100 ms, 200 ms) (S708).

The AUI module 200 counts the received number of times of the acoustic signal (S709), and determines whether the counted value is a preset number of times (e.g., 2 times, 3 times, 4 times) (S710). If the counted value is less than the preset number of times, the AUI module 200 transmits a signal requesting generation of the acoustic pattern to the pattern learning APP so that step S711 and step S704 may be performed and step S706 to step S710 are repeated the preset number of times.

If the AUI module 200 receives the acoustic data the preset number of times, the AUI module 200 analyzes the received acoustic data to extract an important feature point of the acoustic pattern and to calculate a classifier coefficient (S712). Further, the AUI module 200 registers (stores) the important feature point of the acoustic pattern and the classifier coefficient as a feature of the acoustic pattern with respect to a preset function (S713).

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An acoustic pattern learning method, comprising:
setting a learning mode according to a learning start instruction received from a mobile device;
receiving an acoustic signal a preset number of times;
providing information on the acoustic signal each time the acoustic signal is received;
receiving a feature of an Auditory User Interface (AUI) pattern recognized by the mobile device; and
registering the feature of the AUI pattern as corresponding to a preset function.

2. The acoustic pattern learning method of claim 1, further comprising
analyzing a rhythm pattern of each acoustic signal received to extract knock interval information when the AUI pattern is a rhythm pattern,
wherein the information on the acoustic signal is the knock interval information.

3. The acoustic pattern learning method of claim 2, wherein the feature of the AUI pattern includes knock interval information which is an average of knock interval information on a rhythm pattern of each acoustic signal.

4. The acoustic pattern learning method of claim 1, wherein when the AUI pattern is an acoustic pattern, the information on the acoustic signal includes acoustic data of a preset time length.

5. The acoustic pattern learning method of claim 4, wherein the feature of the AUI pattern includes a feature point and a classifier coefficient with respect to acoustic data received a preset number of times.

6. An acoustic pattern learning system, comprising:
an Auditory User Interface (AUI) module mounted in an electronic device; and
a mobile device in wired or wireless electronic communication with the AUI module, the mobile device comprising:
a learning support device for changing a mode of the AUI module to a learning mode according to a request from a user;
a learning device for recognizing a feature of an AUI pattern by learning the AUI pattern a preset number of times received from the AUI module and for providing the recognized feature of the AUI pattern to the AUI module; and
an output device for outputting the AUI pattern input from the user in cooperation with the learning device so that the user confirms the AUI pattern, the AUI module comprising:
an AUI control device for changing and setting a mode according to an instruction of the learning support device and for controlling an operation corresponding to a preset mode to be performed; and
an AUI device for providing information on an input acoustic signal to the mobile device in the learning mode, and for registering the feature of the AUI pattern corresponding to a preset function when the feature of the AUI pattern is received from the mobile device.

7. The acoustic pattern learning system of claim 6, wherein the AUI module extracts the feature of the AUI pattern by analyzing the AUI pattern of the input acoustic signal in a normal mode, and compares the extracted feature of the AUI pattern with the feature of the AUI pattern in the learning mode, and instructs the preset function to be performed when the extracted feature of the AUI pattern corresponds to the feature of the AUI pattern.

8. The acoustic pattern learning system of claim 6, wherein when the AUI pattern is a rhythm pattern, information on the acoustic signal is the knock interval information on a rhythm pattern of each acoustic signal received.

9. The acoustic pattern learning system of claim 8, wherein the feature of the AUI pattern includes knock interval information which is an average of knock interval information on a rhythm pattern of each acoustic signal.

10. The acoustic pattern learning system of claim 6, wherein when the AUI pattern is an acoustic pattern, the information on the acoustic signal includes acoustic data of a preset time length.

11. The acoustic pattern learning system of claim 10, wherein the feature of the AUI pattern includes a feature point and a classifier coefficient with respect to acoustic data received a preset number of times.
